(19) United States
(12) Patent Application Publication
(10) Pub. No.: US 2017/0354554 A1
(43) Pub. Date: Dec. 14, 2017

(54) Method and Device for Transporting an Incapacitated Person

(71) Applicant: Robin Wearley, San Francisco, CA (US)

(72) Inventor: Robin Wearley, San Francisco, CA (US)

(21) Appl. No.: 15/181,423

(22) Filed: Jun. 14, 2016

(51) Int. Cl. A61G 1/01; A47C 31/11; B64D 11/06

(52) U.S. Cl. CPC A61G 1/01; B64D 11/06; A47C 31/11

(57) ABSTRACT

An emergency device for transporting incapacitated persons. The device is affixed to an existing seat on a mode of transportation, such as an airplane seat, such that it appears to form the upper layer of the seat. If the passenger in the seat becomes incapacitated, the device can easily be detached from the seat, and placed into use as an emergency transportation device. The device includes handles that allow assisting persons to grasp it. The device may be rolled up into compact form when not in use as an upper layer of the seat or as an emergency transportation device. In its compact form, it may be used as a travel pillow.

### FIELD OF THE INVENTION

The present invention generally relates to a flexible stretcher to aid in the transportation of a person unable to move under their own power, and a method for utilizing the same. The device may be affixed to a chair, such that it forms the upper layer of the chair. That upper layer may then be easily detached and used as an emergency stretcher. The device of the present invention may be used on chairs that exist on board means of transportation, including airplanes, trains, buses, and passenger ships. In that manner, persons on board such means of transportation may be evacuated in an efficient manner.

### BACKGROUND OF THE INVENTION

Emergencies or other incidents on public transportation necessitate the evacuation and/or movement of one or more passengers. For example, aircraft personnel have the need to move and/or evacuate passengers in the event of equipment failure, emergency landings, accidents, and other emergency situations.

Similarly incidents on passenger trains, buses, subway cars or automobiles or on other means of transportation may also necessitate movement of more or more persons on board.

The evacuation or movement of disabled, injured, and ill passengers poses a special challenge. Persons who rely on external devices for mobility including wheelchairs, crutches or canes typically cannot evacuate themselves without assistance. Persons who were injured or experienced a medical emergency while on board the airplane or other means of transportation typically also require assistance in order to be moved or evacuated.

In the case of airplanes, Federal Aviation Administration regulations mandate that passengers be evacuated within 90 seconds of an evacuation-triggering incident. The reason for that rule is that smoke inhalation is the number one form of death during an airplane accident. Disabled or injured passengers who are not able to evacuate themselves impede the egress of other passengers, and in some cases prevent a timely evacuation from occurring.

A passenger who relies on an external device for mobility typically does not have that device accessible to them while on board the aircraft or other transportation vehicle. For example, upon boarding an aircraft, a wheelchair-bound passenger is typically transferred from his or her wheelchair to the airplane seat, and then the wheelchair is stored in cargo during the flight. Some airlines store a collapsible wheelchair on board the aircraft for the purpose of transporting a disabled passenger to and from a lavatory. That wheelchair is stored during flight, and typically not available for use during an emergency evacuation. Such wheelchairs are also cumbersome to reassemble, and when time is of the essence, they are not a practical solution for the evacuation of disabled or incapacitated persons.

Similarly, devices such as crutches and canes are typically stored during flight and are not easily accessed by the passenger in need of the device.

Passengers who became ill or injured during flight likewise typically do not have an emergency transportation device to aid in their evacuation immediately available in their immediate environs.

Currently, commercial aircraft seats generally are not comprised of a device to aid in the movement and/or evacuation of passengers who have limited mobility. As a result, if urgent movement of passengers becomes necessary while persons of limited mobility are on board an aircraft, there is a significant risk of delay or injury during the movement and/or evacuation process.

In an emergency situation, it is not practical for a crewmember to retrieve an external device such as a folded, stored wheelchair, and carry it back down the aisle to the passenger in need. That is particularly true in the event that there were a stream of passengers trying to reach the exit, and blocking the path of the crewmember.

As a result the person having limited mobility may typically have to rely on his or her fellow passengers or on aircraft personnel to manually carry him or her off of the aircraft. Such a scenario poses the risk of injury to the person having limited mobility, as well as to the persons who are assisting in the transportation.

Numerous safety devices exist on board commercial aircraft that can be deployed by passengers and/or with the help of crewmembers. For example, oxygen devices are available if needed. To take another example, commercial aircraft seats typically serve as flotation devices when needed, and life vests are likewise available. Additionally, a first aid kit is typically stored on board commercial aircraft. However, typically airline seats and seats on other modes of transportation do not include a top layer that can serve as an emergency transportation device. In addition, airlines and other modes of transportation typical do not contain standard equipment stored on or near a seat that would allow for safe and efficient transportation of an injured, disabled, ill, or otherwise incapacitated person.

The foregoing discussion applies in equal measure to all forms of transportation, such as passenger trains, ships including cruise ships, buses, subway cars or other automotive vehicles.

Accordingly, there is a need for a transportation device that can be readily available on aircraft or other vehicle or means of transportation to safely and efficiently aid in the movement and/or evacuation of a person unable to transport themselves under their own power.

There is further a need for a transportation device that can be available to transport any given passenger on an aircraft or other vehicle during an emergency, regardless of where that passenger is seated on the aircraft or vehicle. For example, if a passenger in need of aid is seated toward the rear of an aircraft or other mode of transportation, yet the only emergency transportation device is stored in the front of the aircraft or other mode of transportation, it will not be convenient to easily deploy that stored device for the aid of the passenger seated toward the back. The device of the present invention may be located on or near each seat of the aircraft or other mode of transportation, such that it can be used to aid any given passenger.

Storage space on board an aircraft and other systems of public transportation is typically at a premium. Accordingly, there is a need for a transportation device that does not take up storage space or limit passenger space.

Similarly, weighty devices can be impractical on airplanes and other vehicles, given that weight adds to fuel costs. As a result, there is a need for a lightweight emergency transportation device that can be used on airplanes and other vehicles. In addition, weighty devices can be cumbersome to carry. The device of the present invention has the added benefit that it does not add significant weight above and beyond the weight of the person being transported, and is therefore easy to place into use.

There is further a need for a transportation device that can be placed into use at a moment's notice, without need to retrieve it from a storage closet or storage bag.

There is further a need for a transportation device that can be utilized on the seats of existing aircraft or other modes of transportation, without requiring modifications to the existing seats.

Devices for transporting injured, ill or disabled persons exist in the art, but none solve all of the above-mentioned problems in an efficient manner.

For example, stretchers exist that are capable of transporting patients to and from emergency vehicles or from one location of a treatment facility to another location of the facility. However, those devices are not configured for convenient and efficient use on a commercial aircraft or other mode of transportation.

Moreover, emergency stretchers exist that allow for transport of a patient when conventional stretchers are not available. However, such stretchers are not configured for use in airplanes or other vehicles such that they can be easily placed into use at a moment's notice.

Devices for aiding in the transportation of patients on airplanes exist in the prior art, but those devices do not solve the above-stated problems. For example, European Patent No. 0885604B1 describes a device for aiding in the transport of persons on an aircraft. However that device is stored in a storage closet during flight, and is laid atop multiple seats in order to be placed into use. Accordingly, that device does not solve the need for a stretcher that can be placed on board an aircraft without taking up storage space when not in use. In addition, that device does not allow for fast and efficient movement of any given passenger on the plane, with minimal disruption to surrounding passengers.

In addition, devices that exist in the art cannot efficiently and safely be used during a slide evacuation on an airplane. For example, a wheelchair cannot safely be sent down an evacuation slide with a passenger in the chair. Similarly, a non-flexible stretcher may not safely be sent down an evacuation slide as it may puncture the slide or otherwise fail to conform to the slide. The flexible stretcher device described herein may be sent down the slide with a person on it, and then collected on the other end such that the person can be carried to safety. These and other benefits of the present invention are described in detail herein.

### SUMMARY OF THE INVENTION

The current invention addresses the foregoing issues and drawbacks. In one embodiment, the device of the present invention may be affixed to an existing seat of an airplane or other means of transportation, such that it appears to form the outer, or top layer of the seat. The device may be easily detached from the seat and converted into an emergency transportation device to aid in the evacuation or movement of the passenger in the seat.

In another embodiment, the device of the present invention may be rolled or folded into a compact form for transportation and storage. In that embodiment, the device may be stored in an easily accessible location on the vehicle or means of transportation, and/or carried on board by disabled passengers in case emergency should arise.

When the device is in its compact form, it may also be used as a travel pillow as described herein.

When the device is unrolled and placed onto a seat, the device may preferably have a pocket, as described herein. When the device of the present invention is rolled into its compact form, it may be rolled or folded from the top down toward the pocket at the bottom of the device. In that manner, the rolled material may then be tucked into the pocket. The pocket may then be secured in its compact form with a closure means. In that embodiment, the device has a compact form suitable for storage and carrying. In that embodiment, the compact form may have the rectangular size and shape of a typical travel pillow, and may be utilized as such. When the device of the present invention is unrolled and placed on a seat, the pocket may be used to store devices such as books, tablets, computers, telephones, or other devices that a passenger may with to have accessible during travel.

In the embodiment in which the device of the present invention is affixed to a seat, the device may be easily removed to form a flexible stretcher. The flexible stretcher may preferably include handles that can be grasped for easy use. In that manner, the person in need of aid may be quickly carried off of the aircraft or other vehicle, without risk of injury or unnecessary delay in evacuation.

One advantage of the current invention is that the device may be easily placed on every seat on an airplane, train, bus, or seat on another mode of transportation.

As a result, each passenger may then have an emergency transportation device readily available. Persons who do not regularly rely on external transportation devices, but who become unexpectedly ill or injured on the flight, or during transit by another mode, will have an emergency device available when needed. In addition, persons who do regularly rely on an external device to aid in mobility, but who do not have that device accessible will likewise have an emergency device available to them if needed.

Yet another advantage of the current invention is that the device effectively allows the airline seat, or seat on another mode of transportation, to be converted into an emergency transportation device. As a result, the passenger in need of assistance does not need to be moved from their seat and onto a separate emergency transportation device. Instead, the passenger may preferably remain in place, and be easily lifted and transported. Eliminating the step of moving the passenger onto a separate transportation device is desirable because it reduces the risk of injury and reduces delay in moving the passenger. In addition, eliminating the step of moving the passenger onto a separate transportation device is desirable because it allows the person to be transported both on the mode of transportation and on the ground, without being moved. In the embodiment in which the device of the present invention is used on an aircraft, the person in need of aid may be carried down the aircraft aisle on the device of the present invention, placed on the emergency slide, and retrieved at the end of the slide and carried to an ambulance or otherwise given aid, all without being moved off of the device of the present invention. The same applies when the device of the present invention is used on other modes of transportation. For example, a passenger on a ship may be evacuated from the ship on the device, and taken to receive aide without being moved off of the device.

As stated above, given the FAA's 90-second limit for evacuations, even a matter of seconds can make a difference in terms of saving lives during an emergency. Thus, the lack of need to assemble or unpack an emergency device is an improvement over prior art.

An alternate embodiment exists in which the device of the present invention is not pre-installed on a seat, but is instead rolled into compact form for transportation and storage.

In that embodiment, the device may be carried on board the transportation vehicle with a disabled passenger in case of emergency. Alternatively, one or more devices of the present invention may be stored aboard the vehicle in case of emergency.

In the case of a commercial aircraft, the airline may preferably store the device of the present invention in an easily reachable location, such as under the seat, on the facing seat back, or in a nearby compartment for easy retrieval.

As described herein, in the embodiment in which the device is rolled into compact form when not in use, the device has the advantage that it is not disassembled or placed into a separate bag for carrying. Instead, it is rolled into itself, such that time does not need to be expended removing it from a bag or otherwise assembling it for use.

The device of the present invention is preferably made from a material that is strong enough to support an adult who is being transported in the device, without adding to the bulk of the seat when affixed to a seat.

The device of the present invention may preferably be used on board public transportation vehicles without necessitating adjustment to existing vehicles or to the seats on those vehicles.

### BRIEF DESCRIPTION OF THE DRAWINGS

FIG. 1 depicts a top view of one embodiment of the present invention as unrolled and lying flat on a surface, such as on a floor.

FIG. 2 depicts a seat and the manner in which the device of the present invention is attached to the seat.

FIG. 3 is a front view of the device of the present invention when it is rolled into a compact form to be transported, stored, or used as a travel pillow.

FIG. 4 is a top view of another embodiment of the present invention as unrolled and lying flat on a surface, such as on a floor.

FIG. 5 is a front view of one embodiment of the device of the present invention as attached to an airline seat.

FIG. 6 is a side view of one embodiment of the device of the present invention as attached to an airline seat.

FIG. 7 is a rear view of one embodiment of the device of the present invention as attached to an airline seat.

FIG. 8 depicts one embodiment of the present invention in which it is being placed into use as an emergency transportation device to transport a person unable to move under her own power.

### DETAILED DESCRIPTION OF THE PREFERRED EMBODIMENTS

The current invention may preferably provide a device for transporting a person unable to move under his or her own power.

The device may preferably be used on airplanes for the transportation of one or more airplane passengers.

In alternate embodiments, the device of the present invention may also be used on other modes of transportation including trains, buses, subway cars, cruise ships, or other vehicles.

The device of the present invention may preferably be affixed to seats in transportation vehicles, such that it forms the upper layer of the seat. If the person sitting in the seat needs to be moved and is unable to move under his or her own power, the device may be easily detached from the seat and used as an emergency transportation device.

The device may preferably be installed as standard equipment on airplane seats or seats located on other modes of transportation. When the device is installed on the aforementioned seat, it has the added advantage that it is available for immediate use by any passenger who either has limited mobility, or who becomes ill, injured or otherwise incapacitated while on board the transportation vehicle. When the device is used on commercial aircraft, the airline personnel may give safety instructions at the start of the flight, which include instructions as to how to detach and use the device as a stretcher, or emergency transportation device, in the event it becomes necessary to do so.

The device may preferably be affixed to existing transportation seats without modifying the seats or installing new seats.

The device may preferably be affixed to the seats such that it can be easily and quickly separated from the seat and placed into use while the person in need of aid remains seated.

The device preferably does not diminish the comfort of existing seats in airplanes or other transportation vehicles. Likewise, the device preferably does not limit existing passenger space, or otherwise interfere with the passenger's experience on board the vehicle when the device is not being placed into use as a transportation device.

In an alternate embodiment, the device may be rolled into a compact form for easy storage and transportation. In that embodiment, the device may be stored in an easily accessible location on board an aircraft or other transportation vehicle. For example, the device could be affixed beneath the seats for easy retrieval. Alternatively, the device could be placed on the seat back, or in a nearby compartment. The device may also be placed in a personal carry-on bag, purse, briefcase or other similar device where it may be easily retrieved.

The current invention is now described with reference to the figures. Components appearing in more than one figure bear the same reference numerals.

The device of the present invention is formed from material 20. As described herein, material 20 may be comprised of one or more layers. It may be a single layer, or it may have a top layer and a bottom layer. In the embodiment in which it is comprised of a top layer and a bottom layer, it may have cushioning between the layers as described further herein.

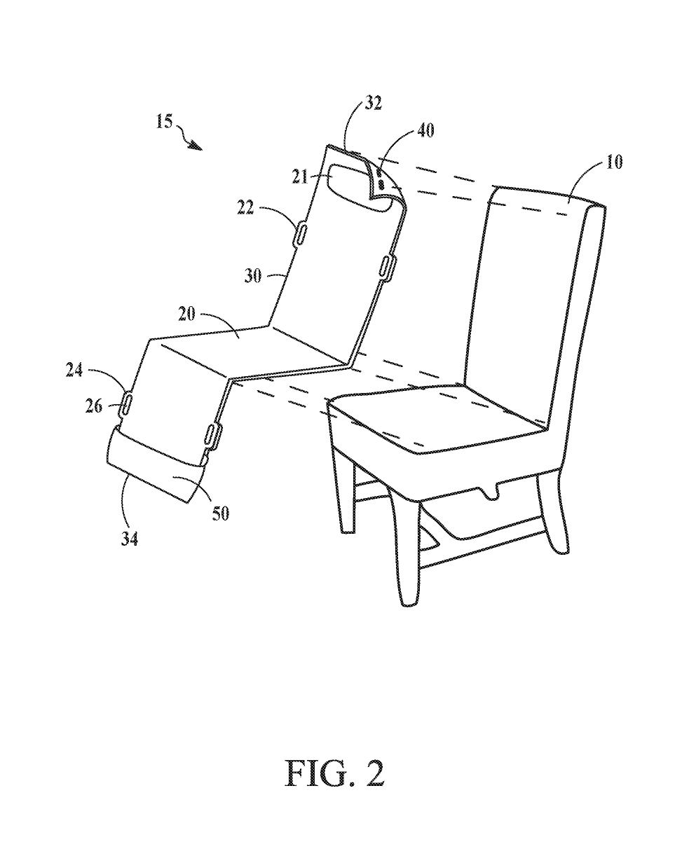

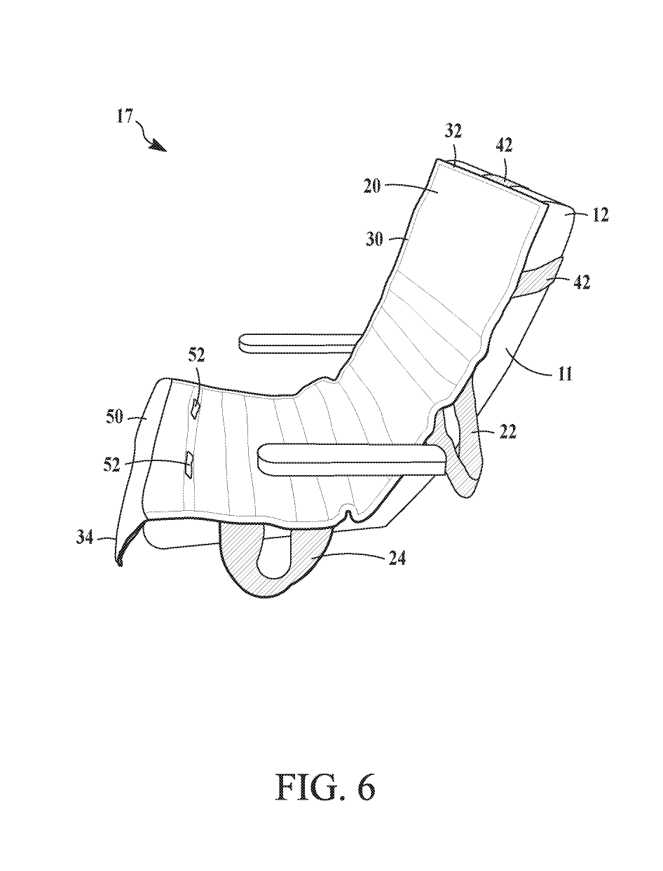

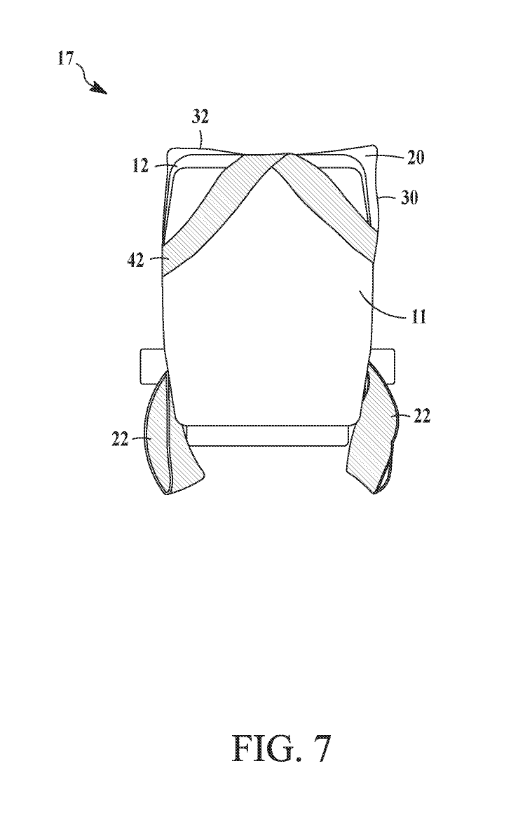

As shown in FIGS. 2 and 5-7, material 20, may preferably be fitted around a chair, or seat 10, such that it forms a detachable upper layer of the seat, herein referred to as upper layer 17 of the seat 10. When the person sitting on seat 10 needs to be moved, upper layer 17 may easily be detached from seat 10 and turned into stretcher 15 such that the person in the seat may easily be transported.

Seat 10 may consist of any type of seat. It may be located on a means of transportation, such as a train, a ship, an automobile, or any other means of transportation. Alternatively, seat 10 could be any other seat, including a seat at a restaurant, musical or other event, or any other seat. In that manner, a person who relies on an external device for transportation, such as a wheelchair, may readily have available a means of being transported in case emergency arises.

In one embodiment of the invention, the seat is an airline seat, referred to herein as seat 11. In that embodiment, material 20 may also be fitted around seat 11 such that it forms detachable outer layer 17 of seat 11, and may easily be detached to form stretcher 15.

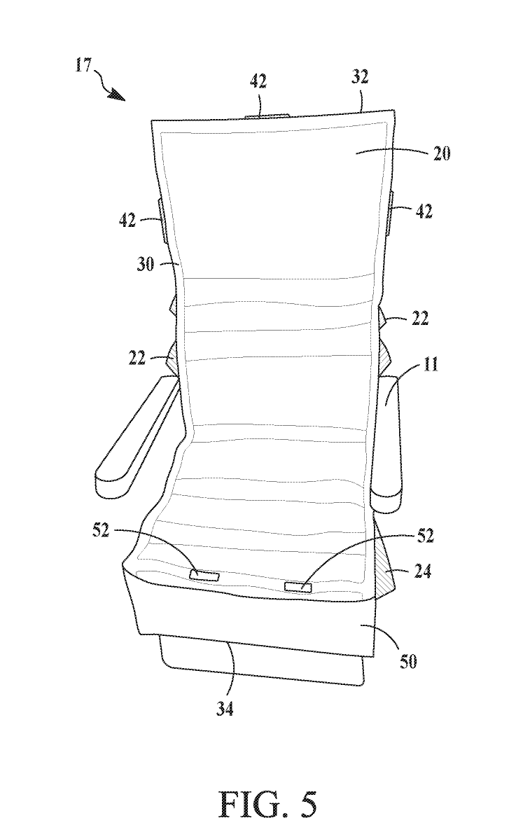

When material 20 is attached to seat 10 or seat 11, top edge 32 is placed on or over the top of seat 10 or seat 11, and bottom edge 34 is located approximately parallel to the bottom edge of seat 10 or seat 11, as shown in FIGS. 2, 5 and 6. Outer edge 30 lies flush against he outer layer of seat 10 or 11 as shown in FIGS. 2 and 5-7. In one embodiment of the invention, material 20, otherwise referred to as stretcher 15, includes straps 42 as shown in FIGS. 5-7. Straps 42 may preferably be formed from an elasticized material. When stretcher 15 is attached to seat 10 or seat 11, straps 42 are placed around the back of seat 10 or seat 11, such that stretcher 15 is held securely in place, and forms detachable outer layer 17 of seat 10 or seat 11. In the embodiment in which straps 42 are formed from an elasticized material, straps 42 may easily be placed over seats of varying width. In the embodiment in which straps 42 are formed from an elasticized material, the straps have the advantage of being able to be securely placed over seats of varying widths, without adding additional bulk to stretcher 15. That embodiment has the additional advantage of ease of manufacturing. In that embodiment, straps 42 may easily be lifted off of seat 10 or seat 11 when upper layer 17 is detached and the device of the present invention is placed into use as stretcher 15. In an alternative embodiment, straps 42 may be adjustable by other means. In that alternative embodiment, straps 42 may be adjusted through means of hooks, clips, or other means of adjusting the length of straps known in the art. In that embodiment as well, straps 42 may easily be lifted off of seat 10 or 11 when outer layer 17 is detached and the device of the present invention is placed into use as stretcher 15.

In that embodiment, straps 42 preferably do not interfere with any screen, tray table, or any other device on or aspect of seatback 11.

In still another embodiment of the present invention, stretcher 15 may not have straps 42 and may instead have attachment means 40 as shown in FIG. 2. Attachment means 40 may preferably take the form of a detachable adhesive, such as Velcro. In that manner, stretcher 15 may be easily affixed to seat 10 or seat 11, regardless of the dimensions of the seat, to form outer layer 17. In that embodiment, outer layer 17 may easily be detached from seat 10 or seat 11 when the device of the present invention is placed into use as stretcher 15. Attachment means 40 may alternatively take the form of other means of attachment known in the art, including other forms of adhesive, snaps, hooks, zippers, or other similar means of attachment known in the art. Attachment means 40 allows the device of the present invention to be attached to seat 10 or 11 without requiring modifications to the existing seat.

In one embodiment of the present invention, stretcher 15 includes headrest 21. As shown in FIG. 2, headrest 21 may preferably located such that it is on or near a passenger's head, when the passenger is seated in seat 10 or seat 11, and stretcher 15 is affixed to the seat such that it forms detachable outer layer 17. Headrest 21 may consist of stitching for aesthetic reasons. In that manner, if seat 10 or seat 11 already has a built in headrest, headrest 21 serves to outline the existing headrest for aesthetic reasons. In an alternate embodiment, headrest 21 may consist of a layer of foam or other cushioning material placed inside the layers of material 20. In an embodiment in which material 20 is comprised of multiple layers, the foam or other cushioning material of headrest 21 may be locate between those multiple layers. Alternatively, an additional layer may be sown on the top of material 20, in order to form headrest 21. In that manner, if seat 10 or seat 11 does not have an existing headrest, then headrest 21 adds to the comfort of the passenger when stretcher 15 is placed over the seat such that it forms detachable outer layer 17. In that embodiment, the cushioning material of headrest 21 may consist of foam, cotton, down, or any other lightweight cushioning material known in the art. In that embodiment, when stretcher 15 is rolled into compact form 16, headrest 21 adds cushioning to compact form 16. Thus, when stretcher 15 is used as a travel pillow, the pillow has additional cushioning for the comfort of the user. In alternate embodiments, stretcher 15 does not have a headrest 21.

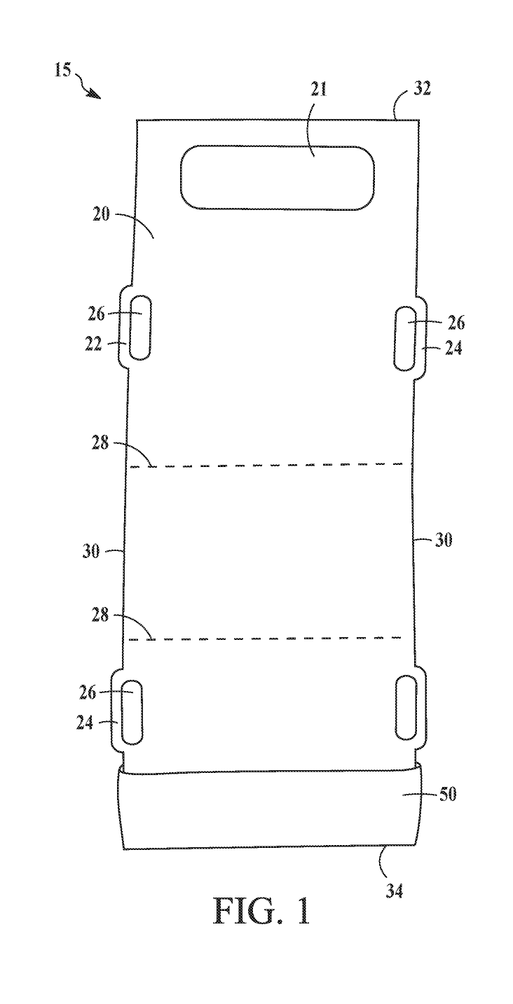

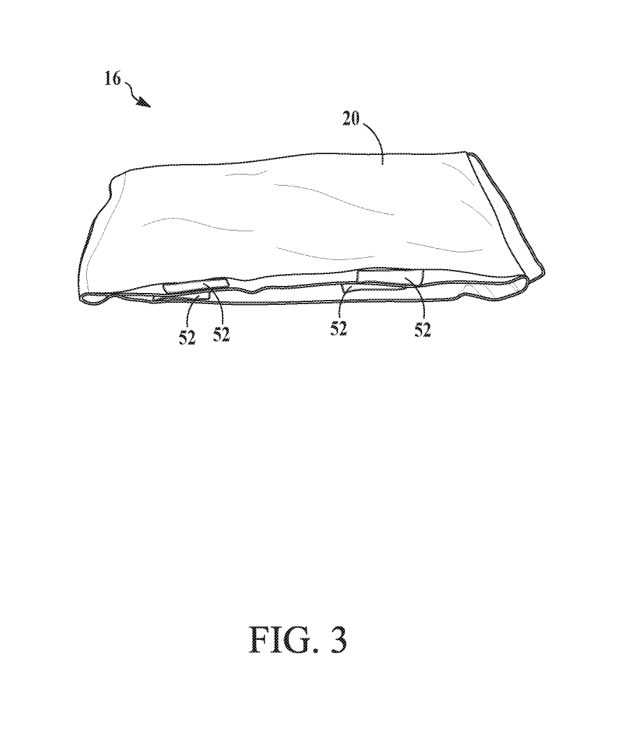

As shown in FIGS. 1, 2, and 4-8, stretcher 15 preferably has upper handles 22 and lower handles 24, which both preferably lie flat against the seat when the device is not in use as stretcher 15. In that manner, the handles will not interfere in any way with the passenger experience when stretcher 15 is not being used as an emergency transportation device. Similarly, if handles are formed from holes or openings cut into the fabric, the handles will not interfere with the passenger experience. As shown in FIG. 3, upper handles 22 and lower handles 24 allow stretcher 15 to be rolled into compact form 16 without interference.

As shown in FIGS. 1-2 and 4-8, upper handles 22 may preferably be located such that they are in line with or near the shoulder blades of an adult, when the adult is seated on upper layer 17, or being transported on stretcher 15.

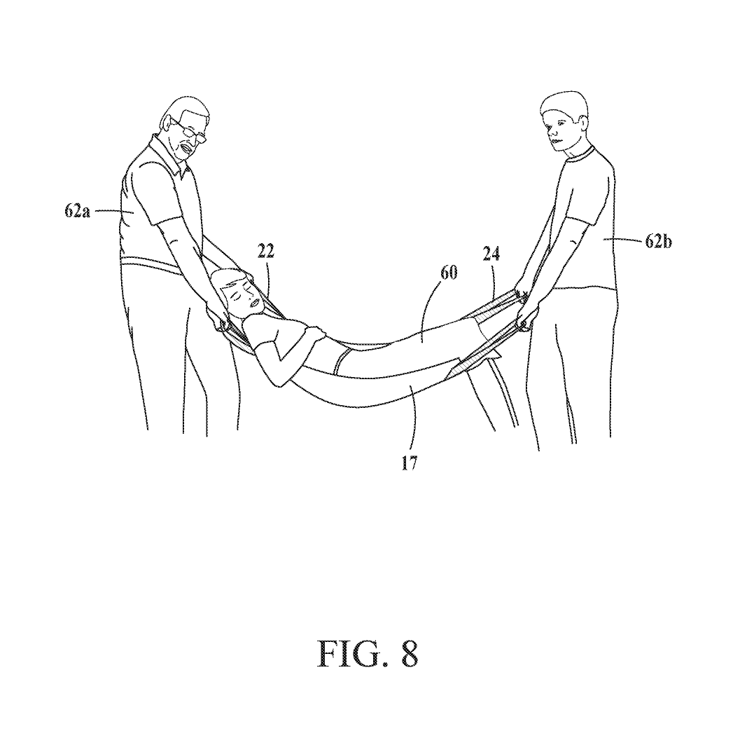

As shown in FIGS. 1-2 and 4-8, lower handles 24 may preferably be located such that they are in line with or near the knees of an adult, when the adult is seated on upper layer 17, or being transported on stretcher 15. As shown in FIG. 8, when the device of the present invention is placed into use as stretcher 15 in order to transport incapacitated person 60, assisting person 62a and assisting person 62b may grasp upper handles 22 and lower handles 24 in order to transport incapacitated person 60. In an alternative method of using stretcher 15, assisting person 62a may stand at or near the head of incapacitated person 60, and grasp both upper handles 22. Assisting person 62b may then stand at or near the knees and legs of incapacitated person 60 and grasp both lower handles 24. That method of using stretcher 15 may preferably be employed in narrow spaces, such as the aisle of an airline, in which there is not enough space for persons 62a and 62b to stand to each side of stretcher 15.

Upper handles 22 and lower handles 24 may preferably have a double layer of stitching attaching them to material 20. In that manner, upper handles 22 and lower handles 24 are affixed to material 20 in a secure and sturdy fashion.

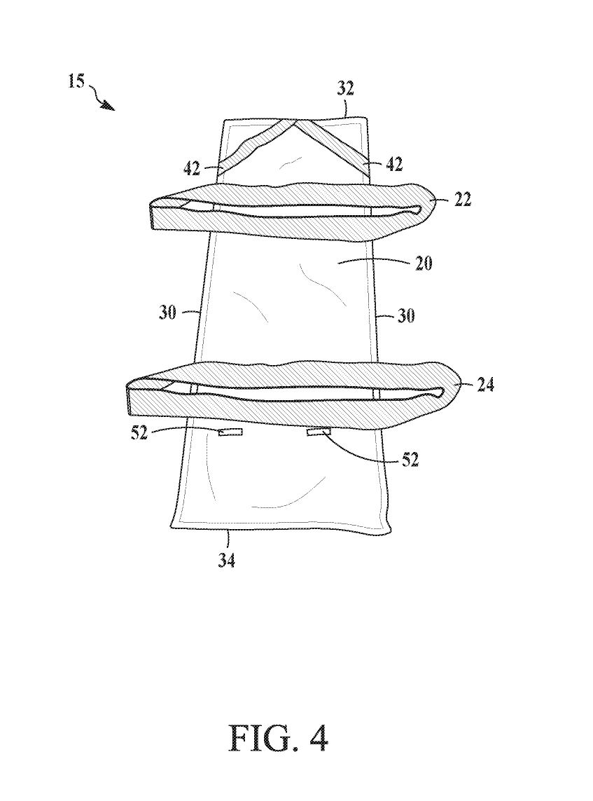

As shown in FIG. 4, upper handles 22 and lower handles 24 may preferably be formed from a single loop of material for added strength and stability.

Alternate means of manufacturing upper handles 22 and lower handles 24 may also be used. For example, as shown in FIGS. 1 and 2, stretcher 15, upper handles 22 and lower handles 24 may all be formed from a single piece of material. In that embodiment, opening 26 allows assisting person 62a and assisting person 62a to place their hand or hands through opening 26 and carry stretcher 15. Still other means of manufacturing known in the art may be used such that upper handles 20 and lower handles 24 are affixed to stretcher 15 in a manner that ensures that they will remain secure when stretcher 15 is placed into use as a transportation device.

Alternate embodiments of the present invention may include differing handle structures. In an alternate embodiment, stretcher 15 may have a single upper handle affixed to top edge 32 of the device and a single lower handle affixed to the bottom edge 34 of the device. In that embodiment, the single upper handle and the single lower handle may each be formed from a loop of material, securely fixed to material 20. Alternatively, the single upper handle and single lower handle may be formed from holes cut into material 20. In that embodiment, when the invention is placed into use, assisting person 62a and assisting person 62b may preferably stand at or near the head of person 60 and at or near the knees and legs of person 60 respectively, when the device of the present invention is placed into use as stretcher 15. In another embodiment of the present invention, the device may have upper handles 22, lower handles 24, in addition to a single upper handle attached to upper edge 32 and a single lower handle attached to lower edge 34. In still another embodiment, stretcher 15 may have additional handles along its outer edge 30, in order to facilitate ease of use.

In one embodiment of the present invention, material 20 includes pocket 50, as shown in FIGS. 1, 2, 5, and 6. Pocket 50 may preferably be made from the same type of material as the rest of the device. When the device of the present invention is manufactured, pocket 50 may preferably be created by folding the lower end of material 20 up, and stitching the folded material back onto to the layer of material 20 such that a pocket is formed. Alternative means of manufacturing pocket 50 may also be employed. When the device of the present invention is attached to seat 10 or seat 11 such that it forms outer layer 17, the pocket is situated underneath the legs of a person seated in seat 10 or 11. The seated person may use the pocket to store items such as books, electronic devices, water bottles, or other items that the person may wish to have nearby and easily retrieved.

When the device of the present invention is placed into use, it may be carried by two assisting persons, depicted in FIG. 8 as persons 62a and 62b. It may alternatively be carried by more than 2 people. For example, stretcher 15 may be carried by up to four people, with two holding opposing sides of upper handles 22 and two holding opposing sides of lower handles 24.

When the device of the present invention is not in use as a transportation device, it may be folded into compact form 16 for storage and transportation, or for use as a travel pillow as shown in FIG. 3. The device may preferably be folded into compact form for carrying and storage, such that it does not need to be placed in an external bag. In order to fold the device into compact form 16, the person folding the device would start with it lying flat, as shown in FIGS. 1 and 4. In the embodiment in which the device of the present invention includes pocket 50, the device of the present invention would be placed such that pocket 50 is lying face up. The person folding the device would then start folding, or rolling it from top edge 32, and fold or roll it toward bottom edge 34. The person would fold or roll the device until reaching pocket 50. At that point, the folded or rolled part of material 20 would be tucked into pocket 50. As shown in FIG. 3, pocket 50 includes closure means 52.

Closure means 52 may preferably take the form of an adhesive, such as a strip of Velcro. The use of an adhesive such as Velcro or another comparable adhesive for such closure means has the advantage of allowing the device to be easily and quickly opened. The use of such an adhesive further has the advantage that it is cost-effective and does not add to the weight or bulk of the device. Many alternate means of closure are known in the art and may be used in connection with the present invention. Those means include, but are not limited to, snaps, buttons, zippers, and hooks. The device of the present invention may then be secured in compact form 16, and may then be easily transported. In that manner, the device of the present invention does not need to be placed into an external bag for transportation or storage.

The device of the present invention may be stored on an airplane, on other means of transportation, or on or near any other seat in compact form 16. In compact form 16, the device of the present invention may be stored on the underside of seat 10 or seat 11. It may be attached to the underside of seat 10 or seat 11 through the means of an adhesive such as Velcro or other similar adhesive, or it may be slipped into a pocket on the underside of seat 10 or 11, or otherwise attached to the underside of the seat. In that manner, each passenger on the transportation device, or each person sitting in the seat, will have an emergency transportation device readily available. When the device of the present invention is being used in a location in which there are multiple rows of seats, such as on an airplane or train for example, the device of the present invention may alternatively be attached to the back of seat 10 or seat 11. For example, in the embodiment in which the device is being used on an airplane, the device of the present invention in compact form 16 may be stored in the seatback pocket of airline seats. In that manner, the device may easily be retrieved from the seatback pocket and placed into use as stretcher 15. The device in compact form 16 may alternatively be stored in a purse or personal carryon luggage, or may otherwise be stored in a location in which it is easily retrieved in the event that it needs to be placed into use as stretcher 15.

When the device of the present invention is in compact form 16, it may also be placed into use as a travel pillow. In that manner, it is readily available in case of emergency. When it is not needed for an emergency, it can be sued to increase the comfort of the traveler or other user.

In the embodiment in which the device of the present invention does not have a pocket 50, it may still have closure means located on top edge 32 and bottom edge 34. In that manner, the device may still be folded into compact form 16, and secured in that form through the use of closure means 52.

Material 20 may preferably sized such that it fits snugly around existing seats, such as airplane seats or seats on other modes of transportation. The dimensions of material 20 may be altered in order to accommodate different seat sizes. For example, when sized to accommodate an airplane seat, the overall dimensions of material 20 may preferably be between 17 inches and 22 inches wide, and the length may preferably be between 55 inches and 80 inches. The device of the present invention may alternatively be easily manufactured using different dimensions.

Material 20 may be made in a variety of fabric colors. It may preferably be made in a color that conforms to the color of the existing airline or other seat.

Material 20 may preferably be made of a single layer of durable material. The single layer of material has the advantage that it is lightweight and does not add additional bulk to a seat. The material is preferably solid, as opposed to mesh for example, such that it has the appearance of a standard airline, train, bus or other vehicle seat when placed over the existing seat. In alternate embodiments, material 20 may be comprised of multiple layers of fabric. In one such embodiment, material 20 may have a cushioning layer between the layers of fabric or material, in order to increase the comfort of the user when the device is used as a travel pillow and when it is used as detachable upper layer 17.

Material 20 may be comprised of a sturdy material such as Denier Coated Oxford. That material has the advantage that it is both flame retardant and sufficiently sturdy to carry an incapacitated adult. Alternative materials known in the art may also be used to form the device of the present invention.

The handles of the device of the present invention may be comprised of a sturdy material, such as canvas. In an alternate embodiment, the handles of the device of the present invention may be comprised of the same material as material 20. In still another embodiment, the handles of stretcher 15 may be comprised of a material with some amount of elasticity. Alternative suitable materials known in the art may also be used in connection with the present invention.

1. A device to transport an incapacitated person comprising:
one or more layers of material;
a plurality of handles located on or near the edges of said at one or more layers of material;
said one or more layers of material sized to fit over a seat; and
a means for attaching the upper edge of said one or more layers of material to the corresponding upper edge of said seat.

2. The device according to claim 1 wherein said handles comprise a single handle located on or near the top edge of said one or more layers of material and a single lower handle locate on or near the bottom edge of said one or more layers of material.

3. The device according to claim 1 wherein said handles comprise two upper handles located on or near said one or more layers of material and two lower handles located on or near said one or more layers of material.

4. The device according to claim 1 wherein said handles are formed from openings in said one or more layers of material.

5. The device according to claim 1 wherein said seat is an airplane seat.

6. The device according to claim 1 wherein a pocket is situated toward the lower end of said one or more layers of material;

7. The device according to claim 1 wherein said one or more layers of material have a closure means to secure the device in a compact form.

8. A device to transport incapacitated persons comprising:
an airplane seat having a detachable outer layer;
said outer layer comprising at least one layer of fabric; and
said outer layer having a plurality of handles at or near its edges;

9. The device according to claim 8 wherein said handles comprise a single handle located on or near the top edge of said detachable outer layer and a single lower handle locate on or near the bottom edge of said detachable outer layer.

10. The device according to claim 8 wherein said handles comprise two upper handles located on or near the top edge of said detachable outer layer and two lower handles located on or near the lower edge of said detachable outer layer.

11. The device according to claim 8 wherein said handles are formed from openings in said detachable outer layer.

12. The device according to claim 1 wherein a pocket is situated toward the lower end of said one or more layers of material;

13. A method of attaching a personal transportation device to a seat comprising:
placing at least one layer of fabric over a seat located on a means of transportation, wherein said at least one layer of fabric is sized to fit over said seat, and wherein said at least one layer of fabric has a plurality of handles; and
securing the at least one layer of fabric to said seat by placing loops of material over the top corners of the seat wherein said loops of material are affixed to said at least one layer of fabric.

14. The method of claim 13 wherein said loops of material are comprised of elasticized material.

15. A method of evacuating a passenger from an airplane comprising:
detaching the upper layer of an airplane seat;
grasping handles located on said upper layer of an airplane seat;
lifting said upper layer of said airplane seat off of the seat while the passenger remains seated; and
carrying said upper layer of said airplane seat off of the airplane.
